(19) United States
(12) Patent Application Publication
(10) Pub. No.: US 2024/0212435 A1
(43) Pub. Date: Jun. 27, 2024

(54) SYSTEM AND METHOD FOR PROGRESSIVE JACKPOT RECONFIGURATION

(71) Applicant: LNW Gaming, Inc., Las Vegas, NV (US)

(72) Inventors: Anandkumar SINGH, Henderson, NV (US); Feven ANDEMESKEL, Las Vegas, NV (US)

(21) Appl. No.: 18/542,000

(22) Filed: Dec. 15, 2023

Related U.S. Application Data
(60) Provisional application No. 63/434,488, filed on Dec. 22, 2022.

(51) Int. Cl. G07F 17/32

(52) U.S. Cl. CPC G07F 17/3227; G07F 17/3234; G07F 17/3258

(57) ABSTRACT

A system and method(s) to perform operations for reconfiguring an in-progress progressive jackpot. The operations include detecting, (e.g., by an electronic processor, a progressive controller, etc.) in response to user input, a request to reconfigure a portion of a setting of a progressive jackpot while the progressive jackpot is in progress. The operations further include storing gaming data associated with use of the setting. The operations further include enabling, by the electronic processor in response to storing the gaming data and while the progressive jackpot remains in progress, reconfiguration of the portion of the setting without requiring reconfiguration of an additional portion of the setting.

### RELATED APPLICATIONS

This patent application claims priority benefit to U.S. Provisional Patent Application No. 63/434,488 filed Dec. 22, 2022. The 63/434,488 application is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD

The present invention relates generally to apparatus and methods for gaming machine configuration and progressive jackpot control.

### BACKGROUND

In some current gaming platforms, there exist several settings that cannot be modified once a game has been played, such as progressive-jackpot settings for wagering games played on one or more gaming machines linked to a progressive jackpot. To change these settings, the gaming machine must be RAM cleared (i.e., the non-volatile random-access memory, or NVRAM, of a gaming machine is cleared) and reconfigured with the new values (e.g., with new contribution values for the progressive jackpot). Furthermore, if the gaming machine is part of a bank of gaming machines that are contributing to the progressive jackpot, then in some instances, all of the gaming machines in the bank may need to be RAM cleared and reconfigured with the new values. This is a time consuming and potentially error prone process as it involves reboots and reconfiguration of one or more entire gaming machines.

It would be beneficial for an innovation that avoids the challenges associated with the current progressive jackpot reconfiguration process and which can modify progressive jackpot settings while the progressive jackpot is in progress.

### SUMMARY

According to an embodiment of the present disclosure, a system and/or method(s) is disclosed to perform operations for reconfiguring an in-progress progressive jackpot. The operations include detecting, by an electronic processor of a gaming machine in response to user input, a request to reconfigure a portion of a setting of a progressive jackpot while the progressive jackpot is in progress. The operations further include storing, by the electronic processor in a memory of the gaming machine, gaming data associated with use of the setting. The operations further include enabling, by the electronic processor in response to storing the gaming data and while the progressive jackpot remains in progress, reconfiguration of the portion of the setting without requiring reconfiguration of an additional portion of the setting.

According to an embodiment of the present disclosure, a system and/or method(s) is disclosed to perform operations for reconfiguring an in-progress progressive jackpot. The operations include detecting, in response to user input, a request to reconfigure a portion of a setting of a progressive jackpot while the progressive jackpot is in progress. The operations further include determining, prior to enabling reconfiguration of the portion of the setting, that one or more criteria are satisfied for authorization of reconfiguration of the portion of the setting. Furthermore, the operations include enabling, without stopping the progressive jackpot, the reconfiguration of the portion of the setting while preventing reconfiguration of an additional portion of the setting. The enabling the reconfiguration is in response to determination that the one or more criteria are satisfied.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example network according to one or more embodiments of the present disclosure.

FIG. 2 is a flow diagram that illustrates an example of reconfiguring an in-progress progressive jackpot according to one or more embodiments of the present disclosure.

FIG. 3 is an illustration of progressive jackpot reconfiguration according to one or more embodiments of the present disclosure.

FIG. 4 is an illustration of progressive jackpot reconfiguration according to one or more embodiments of the present disclosure.

FIG. 5 is an illustration of progressive jackpot reconfiguration according to one or more embodiments of the present disclosure.

FIG. 6 is an illustration of progressive jackpot reconfiguration according to one or more embodiments of the present disclosure.

FIG. 7 is an illustration of progressive jackpot reconfiguration according to one or more embodiments of the present disclosure.

FIG. 8 is an illustration of progressive jackpot reconfiguration according to one or more embodiments of the present disclosure.

FIG. 9 is a perspective view of a free-standing gaming machine according to one or more embodiments of the present disclosure.

FIG. 10 is a block diagram of a gaming system according to one or more embodiments of the present disclosure.

FIG. 11 is a block diagram of a computer system according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

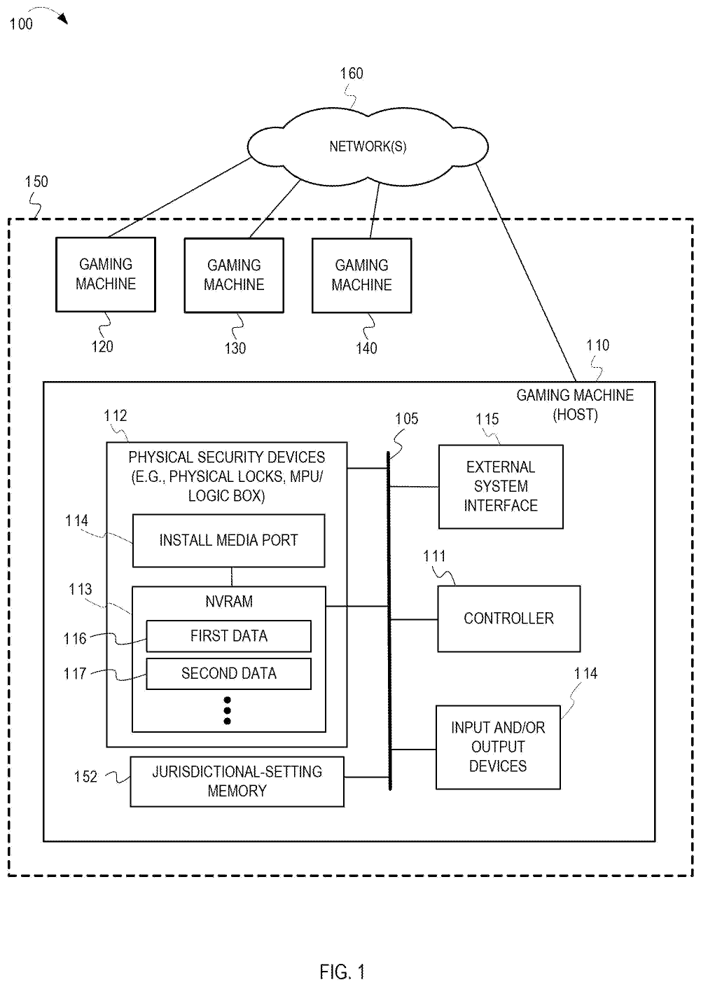

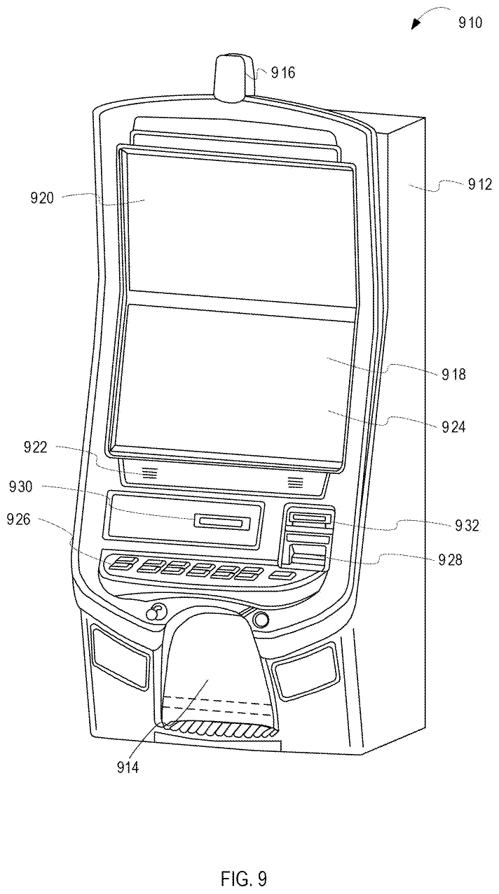

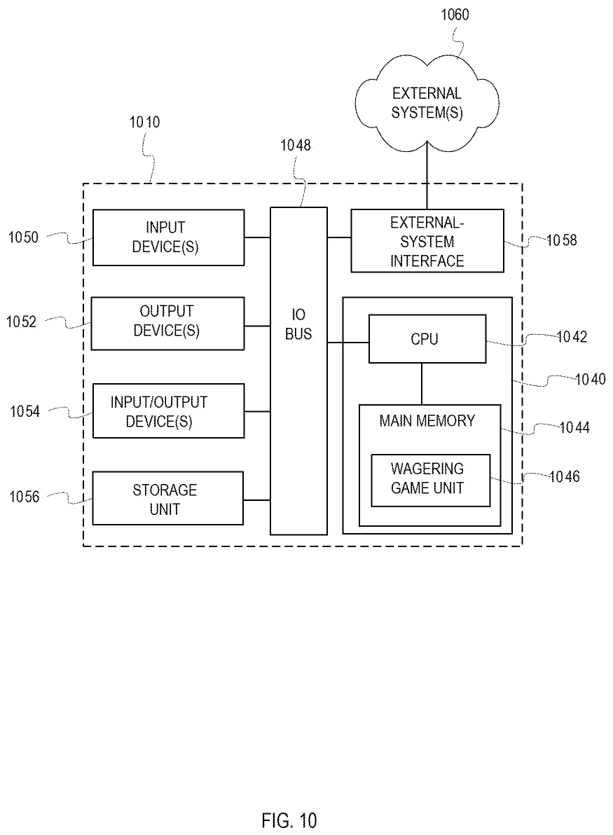

FIG. 1 is a diagram of an example network (“network 100”) according to one or more embodiments of the present disclosure. The network 100 includes one or more gaming machines, such as gaming machine 110 communicatively coupled (e.g., connected within the network 100) to one or more communication networks (“network(s) 160”). In one example, the gaming machine 110 (or any other of gaming machines 120, 130 and/or 140) may be gaming machine 910 described in FIG. 9 or gaming machine 1010 described in FIG. 10.

The gaming machine 110 includes (but is not limited to) a controller 111, physical security devices 112, a non-volatile random-access memory (NVRAM 113), an install media port 114 (connected to the NVRAM 113), input and/or output devices 114 (e.g., primary presentation device 918, secondary presentation device 920, etc.—see FIG. 9), an external system interface 115 (e.g., see also external system interface 1058 in FIG. 10), and a jurisdictional-setting memory 152 connected via a bus 105. The NVRAM 113 stores data for game configuration, game play history, progressive jackpot settings, events, accounting data, etc. In some embodiments, some of the data may be specifically authorized for storage, modification, etc. via a jurisdictional setting (e.g., a limit, restriction, rule, etc.) stored in the jurisdictional-setting memory 152. For example, the jurisdictional setting may specify one or more jurisdictional rules related to a geographic location of the gaming machine 110. In some embodiments, the jurisdictional setting(s) may specify (according to the one or more jurisdictional rules) one or more categories or types of data authorized for storage and or modification of progressive jackpot settings, progressive jackpot data, etc.

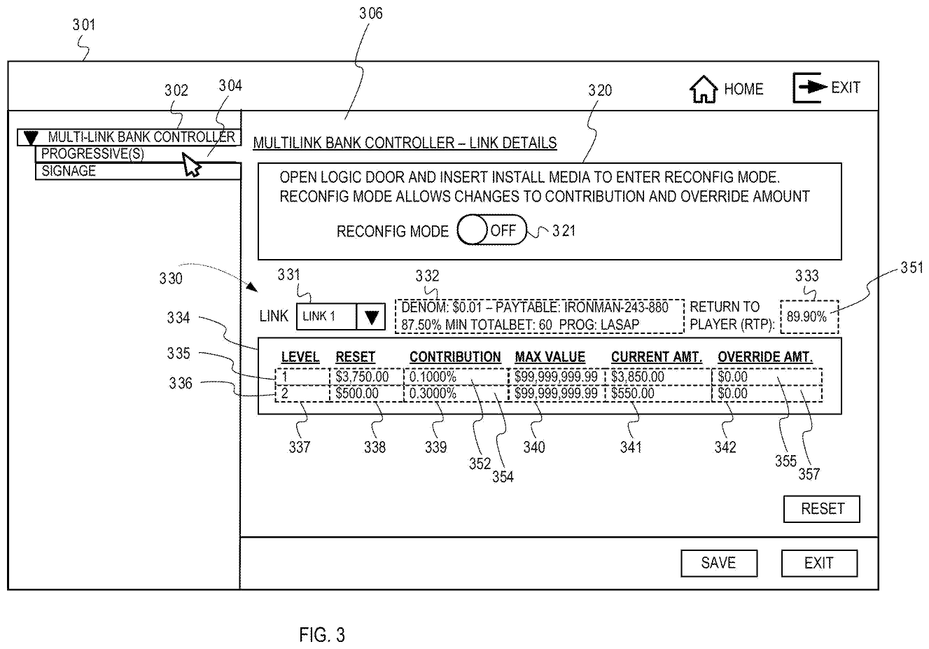

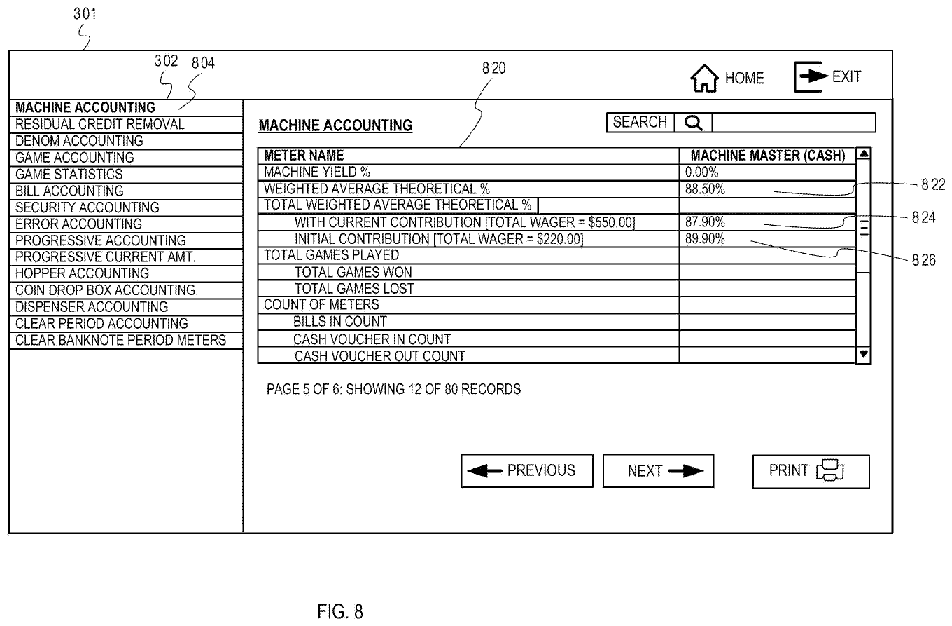

According to some embodiments, the gaming machine 110 is a host that controls (via controller 111) at least one progressive jackpot linked to one or more games available via the gaming machine 110 (and/or available via one or more additional gaming machines 120, 130, 140, etc. connected to the gaming machine 110). The controller 111 is configured to modify (while the progressive jackpot is in progress) some settings, such as a progressive jackpot amount or a change in rate of progression of an existing progressive jackpot, even after some games have been played at an already-set jackpot amount or contribution rate. The controller 111 can enable (e.g., based on certain criteria being satisfied) a reconfiguration mode (or “reconfig mode”) so that modifications can be made to one or more values of the one or more progressive jackpot settings while the progressive jackpot is in progress. A progressive jackpot that is “in progress” or an “in-progress” progressive refers to a progressive jackpot that has already been configured (e.g., linked to one or more gaming machines) and has been started (i.e., has been made available to the linked gaming machines). In some embodiments, an in-progress progressive jackpot has received some wager contributions to the jackpot by one or more of the linked gaming machines. In some embodiments, one or more settings are made modifiable and are modified via an electronic and/or automated tool (e.g., sec configuration menu 301 in FIG. 3 thru FIG. 8). An in-progress progressive jackpot can experience a win, reset to a reset value after the win, then continue to increment again.

The controller 111 (e.g., one or more electronic processors), can (if the criteria is satisfied), modify control settings (e.g., at least a portion of the setting) for the gaming machine 110 (which can also be played as a game client) as well as for one or more additional gaming machines clients (e.g., gaming machines 120, 130, 140, etc.), which may contribute (individually or collectively) to the progressive jackpot. For instance, in some embodiments, the gaming machine 110 may be used in a stand-alone progressive (SAP) configuration (i.e., a single gaming machine contributes to a progressive over time). In other embodiments, the gaming machine 110 is a host that stores and controls progressive jackpot settings and/or controls progressive jackpot configurations and/or reconfigurations (e.g., via the controller 111) for a plurality of gaming machines, including the gaming machine 110 (as a client), as well as other linked client gaming machines (e.g., gaming machines 120, 130, 140, etc.). For instance, the gaming machines 110, 120, 130, and 140 may be communicatively coupled in a local-area progressive (LAP) or “bank” configuration (e.g., a bank 150 of gaming machines connected by an Ethernet switch are linked together to one or more progressive games in a local-area network, where all wagers made by the gaming machines in the bank 150 contribute to the progressive jackpot (or multiple progressive jackpots) over time). In the LAP or bank configuration, one of the gaming machines (e.g., gaming machine 110) acts as the host of the progressive jackpot for the entire bank 150. One example of a progressive controller (e.g., controller 111) that is configured for multiple linked gaming machines (i.e., an LAP) includes the Multilink Bank Controller (MBC) product manufactured by Light & Wonder Inc. The MBC is a bank progressive product that supports the Multi-Link (MML) protocol (developed by Light & Wonder, Inc.) in local and wide area progressives. Hence, in at least one embodiment, the gaming machine 110 is designated as the server and configured as the host controller (i.e., the MBC product is installed and activated on the host gaming machine 110). Remaining gaming machines in the bank 150 connect to the host using the MML protocol.

According to other embodiments, other examples of types of progressives (and accompanying controllers), include a Slot Accounting System Progressive, or SASP (e.g., a linked progressive controller that supports a SAS progressive protocol over a serial line); a WMS Progressive (WMSP) (e.g., a linked progressive controller that provides a WMS progressive service over local and wide areas); a Bally Enterprise Progressive System (BEPS) (e.g., a linked progressive controller that provides progressive service over wide areas and enterprise-wide); a BEPS Express Progressive (e.g., a scaled down version of BEPS providing progressive service over a local area or bank); a G2S Progressive (G2SP) (e.g., a linked progressive controller that supports the G2S progressive protocol); etc.

Furthermore, in some embodiments, the number of links is dictated by the game and the pay tables configured for the game. Hence, for the same bank 150 of gaming machines one or more links can contribute to different pools within the bank 150. For example, within the bank 150, one machine may contribute to two out of five pools, whereas another machine in the bank 150 may contribute to three of the five pools. Therefore, in some embodiments, the controller 111 tracks the different amounts contributed to each pool by each machine and tracks the amounts contributed for each machine separately (e.g., retains a certain number of accounting records per each client, keeps a running history in snapshots regarding the modified contribution amounts per each progressive link and/or per each client, etc.). Thus, the controller 111 provides a fair and accurate history of the contributions, over time, for each client that contributes to a particular progressive, based on a level of contribution of each individual client machine within the bank 150.

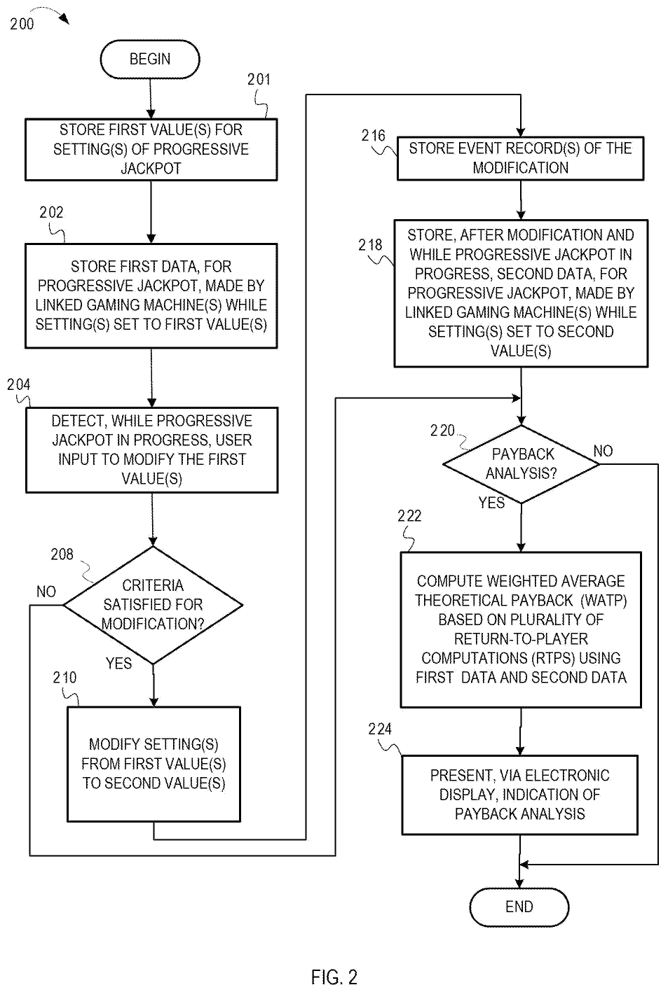

As mentioned, in some embodiments, the controller 111 is configured to reconfigure (e.g., modify) at least a portion of progressive jackpot settings (e.g., a portion of the settings, such as the contribution rate and/or progressive override amount values) for an in-progress progressive. The controller 111 can do so without having to stop progress of the progressive jackpot (e.g., without having to remove access to the progressive jackpot by any linked gaming machine, without having to reboot the host gaming machine or any linked gaming machine, without having to erase a memory (e.g., an entire NVRAM 113) of a gaming machine, etc.), as would be required with a conventional reconfiguration process. Rather, the controller 111 stores different data groupings (e.g., sets of records and/or snapshots of information) associated with each modification of values of the progressive jackpot settings. For example, (as illustrated in more detail in FIG. 2) a processor (e.g., the controller 111) can store and classify first data (first data 116), such as first wager amounts, first contribution amounts, win amounts, games played, etc. for one or more game rounds played (i.e., for a first set of wagers made by the gaming machine(s) 110, 120, 130 and/or 140) when the portion of the progressive jackpot setting(s) are set to one or more first values (“first value(s)”). After the controller 111 modifies the first value(s) (e.g., after modifying a progressive contribution rate or an override value), while the progressive is in progress, the controller 111 stores and classifies second data (second data 117), such as second wager amounts, second contribution amounts, win amounts, games played, etc., made (by any of the gaming machine(s) 110, 120, 130 and/or 140) when the portion of the progressive jackpot setting(s) is/are set to one or more second values (e.g., “second value(s)”) while the progressive jackpot remains in progress. In some embodiments, the controller 111 reconfigures a portion of a progressive jackpot setting (e.g., the contribution rate and/or override amount) without reconfiguring an additional portion of the progressive jackpot setting (e.g., without requiring and/or permitting reconfiguration of a reset value, a max value, etc.). Furthermore, the controller 111 can perform a payback analysis, such as by computing a return to player (RTP) for each separate set of data (i.e., the controller 111 computes an RTP for the first data 116 and an RTP for the second data 117). Furthermore, the controller 111 uses the information from the first data 116 and the second data 117, such as the plurality of RTPs, to generate a weighted average theoretical payback (WATP).

Thus, embodiments provide a real-time modification of values for an in-progress progressive jackpot while retaining separate groups of classified and organized data (e.g., retained in memory of the host gaming machine 110 or elsewhere on a casino network, such as via a gaming server), for subsequent analysis and review. Thus, the in-progress, progressive jackpot reconfiguration mode achieves a real-time reconfiguration without losing information on accounting meters, game play history, significant events including events related to configuration, etc. Furthermore, because the controller 111 modifies the progressive jackpot value(s) without needing to erase or reconfigure the entire NVRAM 111 (or that of other gaming machines 120, 130, 140, etc.), the controller 111 thus reduces gaming-machine down time and potential misconfiguration that may be encountered during a full RAM clear and reconfiguration.

FIG. 2 illustrates an example of a method flow (“flow 200”) of reconfiguring an in-progress progressive jackpot according to one or more embodiments of the present disclosure. The description of FIG. 2 refers to a “processor” that performs operations associated with the flow 200. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, to one or more devices of the network 100, such as any one of the devices connected via the network(s) 160 (e.g., gaming machine 110, gaming machine 120, gaming machine 130, gaming machine 140, etc.). For example, in one embodiment, the processor may be central processing unit (CPU) 1042 (see FIG. 10) or a processor in another device mentioned herein, such as a processor (e.g., processor 1142) associated with the computer 1100, a table controller, a card-handling device, a camera controller, a game controller, server(s), etc. In some embodiments, the processor refers to the controller 111 described in FIG. 1.

Furthermore, FIGS. 1, 3, 4, 5, 6, 7, and 8 will be referenced in the description of FIG. 2.

In FIG. 2, the flow 200 begins at processing block 201, where a processor stores one or more first values (“first value(s)”) for at least a portion of one or more settings (“setting(s)”) of a progressive jackpot. In some embodiments, the first value(s) are stored in response to first user input. In the context of the flow 200, the first values may be referred to herein as having been set by a first user input. The use of the term “first” (e.g., a “first” user input; modification of “first” value(s); etc.) is used to distinguish a difference in sequence from that of a subsequent or “second” event or action (e.g., as in a “second” user input; modification of “second” value(s), etc.). It should be noted that additional user inputs may be made and/or additional modifications may be made to one or more values of the progressive jackpot setting(s) prior to the first user input and/or prior to the setting of the first value(s), as well as additional user inputs may be made and/or additional modifications may be made to the value(s) of the progressive jackpot setting(s) subsequent to, intermediary to, or concurrently with, modification to the second value(s).

Referring to FIG. 3, the processor presents a gaming-machine configuration menu (configuration menu 301), via a display (e.g., via a display of gaming machine 110). The configuration menu 301 includes a navigation menu 302 with presents one or more options for configuration, such as option 304 related to configuration of progressive jackpot setting(s). The setting(s) include the progressive jackpot settings (setting(s) 330), which are displayed in section 306. A sub-section 320 presents a user-interface control (e.g., toggle button 321) by which the reconfiguration mode can be turned on or off. The sub-section 320 presents information related to criteria (e.g., conditions, requirements, etc.) that enable the toggle button 321 to be activated. Some of the criteria (e.g., accessing a physical security device 112 such as opening a logic door, installing media into a specific media port, such as install media port 114, etc.) is descried in more detail in association with processing block 208. Prior to the reconfiguration mode being enabled, the processor stores (e.g., via configuration menu 301) the first value(s) for setting(s) 330. The setting(s) 330 include a link-selection button 331 from which a specific link name can be selected (e.g., “Link 1” for a first link to a first progressive jackpot, ‘Link 2” for a second link to a second progressive jackpot, etc.). The setting(s) 330 also include details 332 related to denomination values, paytable information, etc. The setting(s) 330 can further include a field 333 in which an RTP value 351 is automatically computed and presented based on data associated with the first value(s) and, in some examples, based on additional value(s) set (for the in-progress progressive jackpot) prior to the first value(s) being set. The setting(s) 330 further include a table 334 that specifies columns of values for some of the setting(s) 330. A first column 337 refers to a level of the progressive jackpot. The progressive jackpot can have multiple levels (e.g., a first level or level “1,” and a second level or level “2”). Values for the different levels are stored in rows 335 and 336 respectively. A second column 338 refers to a reset value of the progressive (e.g., a value which the progressive will reset to after hitting and being awarded to a winning participant). A third column 339 refers to a contribution rate (i.e., a percentage of a wager that is contributed to the progressive jackpot). As shown in FIG. 3, the values of the contribution rate have been set to a first set of values (i.e., value 352 and value 354) for the respective levels. A fourth column 340 refers to a maximum value that the progressive jackpot is permitted to attain. A fifth column 341 refers to a current amount to which either of the levels of the progressive jackpot has grown. A sixth column 342 refers to an override amount, or rather, a specified amount that would (if modified) override the current amount (shown in column 341). The values shown in the table 334 were set previously (e.g., during an initial configuration of the gaming machine 110, during a previously authorized modification, etc.).

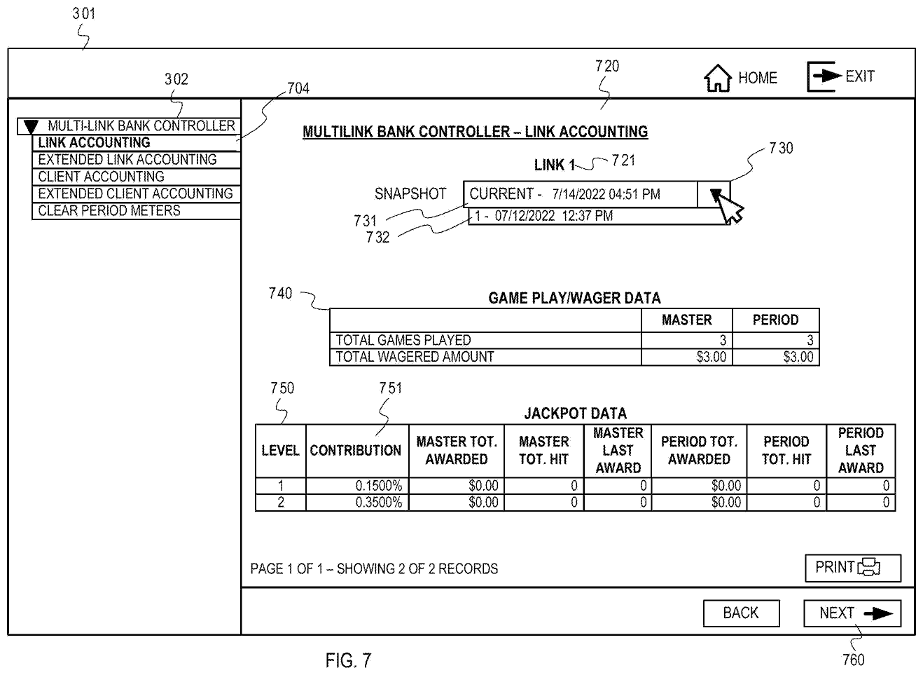

Referring momentarily back to FIG. 2, the flow 200 continues at processing block 202, where a processor stores first data made by the one or more linked gaming machine(s) while at least the portion of the setting(s) are set to the first value(s). For example, the processor can (e.g., as controller 111 of the host gaming machine 110) store and classify the first data (e.g., first data 116) for any wagers made by any of the gaming machines 110, 120, 130 and/or 140 while the progressive jackpot setting(s) (e.g., setting(s) 330) is/are set to the first value(s). The first data may include, but not be limited to, wager amounts, contribution amounts, games played, games won, etc. The processor can generate (organize and save in a persistent memory partition) a snapshot of progressive meters and/or game data generated while the at least the portion of setting(s) are set to the first value(s). The snapshots can be displayed from a link accounting page of the reconfiguration tool (e.g., for regulatory inspection, for fairness evaluation, etc.). FIG. 7 illustrates an example of link accounting information 720 presented regarding snapshots of progressive jackpot data generated by the gaming machine(s) while the setting(s) 330 are set to one or more specific values. For instance, the values for the setting(s) 330 (including the one or more first value(s) related to at least a portion of the setting(s) 330) as well as gaming data related to use of the values(s) (including use of the one or more first value(s)) may be stored in a first snapshot related to entry 732 of dropdown menu 730. For example, the first snapshot of data includes information about game play and/or game wager data (e.g., information presented in table 740), which species a number of games played and/or a total wagered amount made while the at least the portion of the setting(s) 330 were set to the first value(s). Additionally, jackpot data may be specified in table 750 regarding the one or more of the first value(s), such as a column 751, which specifies a contribution rate for any given set of values. As shown in FIG. 7, the dropdown menu 730 selects a snapshot entry 731, which relates to second value(s) stored in setting(s) 330 (described in further detail at processing block 218). If, however, the entry 732 were to be selected, the amounts in the table 750 would specify first value(s) (e.g., column 751 would instead show value 352 and value 354 of column 339 shown in FIG. 3). Further description of FIG. 7 occurs in connection with processing block 218, for instance, after the one or more values for the setting(s) 330 have been modified from the first value(s) to the second value(s).

Referring momentarily back to FIG. 2, the flow 200 continues at processing block 204, where a processor, detects, while the progressive jackpot is in progress, a user input to modify the first value(s). In one example, the user input may include toggling a switch that enables the reconfiguration mode. For example, as shown in FIG. 3, the toggle button 321 can be toggled, via user input, from an “OFF” value to an “ON” value. In one instance, the toggle button 321 may not be modifiable unless one or more criteria are satisfied to enable the toggle button 321 to be activated. Thus, as illustrated in FIG. 3, none of the fields within the table 334 are modifiable yet, rather they only show the previously set, first value(s).

Referring momentarily back to FIG. 2, the flow 200 continues at processing block 208, where the processor determines whether specific criteria is/are satisfied that permits a modification of the first value(s) of the setting(s). The modification of the first value(s) may, in some embodiments, require a specific degree of security measures to ensure that only authorized access is permitted. For example, one criterion can include detecting a trigger signal from a memory protection unit (MPU), such as a signal from a sensor (e.g., of the physical security devices 112) of a logic-box door (“logic door”). The signal is generated, by the sensor, to indicate that the logic door has been securely accessed (e.g., a sensor on the door indicates that the door is in an open state). If the signal indicates that the logic door is securely accessed (i.e., opened), then at least one criterion (of the criteria for processing block 208) is satisfied, and the flow 200 may continue to processing block 210 (given other required criteria are also satisfied) where the processor modifies the progressive jackpot settings from the first value(s) to one or more second values (“second value(s)”). Otherwise, the flow continues at processing block 220.

Another example criterion can include determining whether jurisdictional settings related to the location of the gaming machine (e.g., jurisdictional rules 152, location settings, etc.), indicate whether modification of value(s) of progressive jackpot setting(s) is authorized or permissible. In some embodiments, the processor can determine whether a jurisdictional setting (e.g., rule) permits the modification of certain kinds of progressive data, such as of certain data types, certain classifications/categories of data, data related to a specific function or purpose, etc. One example of such a rule is Section 3 Nevada Regulation/Standards 2.010, which specifies that the “theoretical payback percentage of a gaming device must not be capable of being changed without making a hardware or software change in the device except as provided for in Technical Standard 1. For purposes of this standard, the addition of an attendant-paid bonus, a progressive jackpot, or a change in rate of progression of an existing progressive jackpot is not considered to be a change in the theoretical payback of the gaming device.” Hence, in one embodiment, if the gaming machine is in a jurisdiction associated with the jurisdictional rule, then a jurisdictional setting can be set (e.g., by an operator, automatically by controller 111, etc.) to specify that a change to a value of the progressive jackpot (e.g., an override value) or a change to a rate of progression of the progressive jackpot (e.g., a contribution value) is modifiable by jurisdictional rule. In other embodiments, the processor (e.g., controller 111) can automatically read and determine (e.g., via neural network model(s), via natural language processing, etc.), what is permitted (by the rule) to be modifiable. For example, the processor can determine (e.g., either automatically and/or in response to user input) that two of the columns (e.g., column 339 and column 342) refer to values that are not considered to be a change in a theoretical payback of a gaming device according to the jurisdictional setting and/or rule, and, hence, that the jurisdictional setting or rule permits modification to those types of values.

Another example criterion includes determining whether the gaming machine has any credits on it. For example, the processor determines whether the gaming machine (e.g., the host gaming machine and/or any other gaming machines linked to the progressive jackpot) is currently actively wagering, which could potentially result in a conflict of data and/or result in a possible error during the reconfiguration of value(s) of progressive jackpot setting(s). Hence, in one embodiment, the processor can ensure that no credits are on the gaming machine.

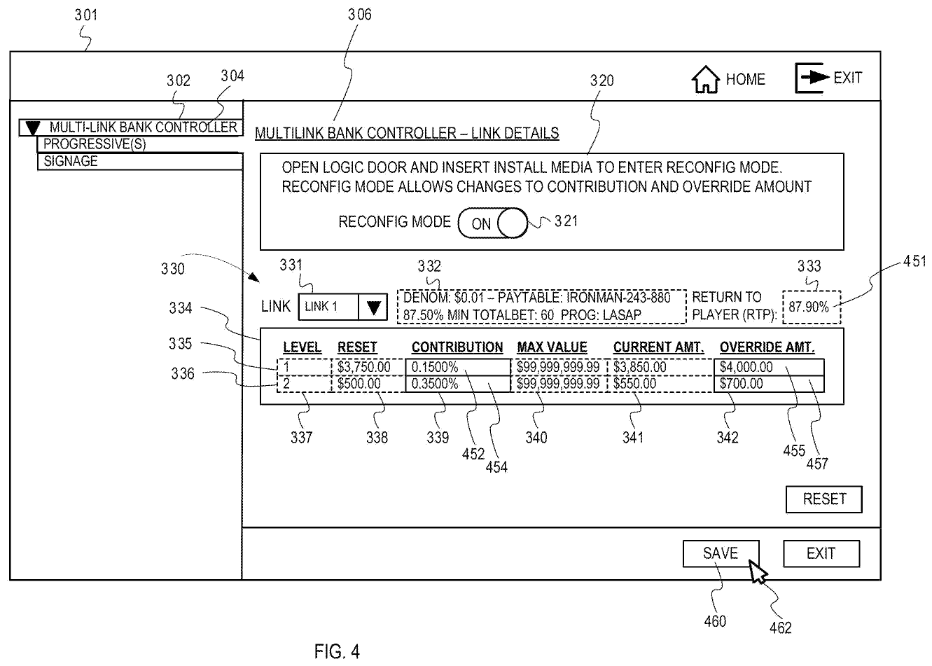

As illustrated in FIG. 4, the toggle button 321 is enabled if specific criteria are met (e.g., if physical security devices 112 indicate that a logic door is open and/or if install media is inserted into the install media port 114). The logic door is a door of the gaming machine that is inside of the main cabinet. The logic door protects the RAM and the hardware. Opening the logic door is a security measure that ensures that only authorized individuals are accessing the gaming machine for installation of software and/or for reconfiguration of already set values. This is also a security measure performed for a RAM clear and reconfiguration procedure. Thus, in some embodiments, some similar security mechanisms that are used for clearing and reconfiguring the machine can also be used for enabling the option to toggle the reconfiguration mode (i.e., requiring access to the logic door, using a specific USB port, etc.).

Referring momentarily back to FIG. 2, the flow 200 continues at processing block 210 (given that the one or more required criteria are satisfied) where the processor modifies the at least the portion of the setting(s) from the first value(s) to one or more second values (“second value(s)”). In some embodiments, the processor modifies the at least the portion of the setting(s) while the progressive jackpot remains in progress. For example, the processor does not stop the progressive jackpot. Rather, the processor stores and organizes data related to the differences in the modified values. Further, in some embodiments, the processor does not need to reboot the host gaming machine 110 (or any other linked gaming machine(s) 120, 130, 140, etc.), rather the processor will continue using the modified values for the progressive jackpot. The processor also does not need to erase the NVRAM 113 of the host gaming machine 110. Further, the processor modifies the at least the portion of the progressive jackpot settings and without requiring reconfiguration of an additional portion of the settings (e.g., without requiring reconfiguration of non-modifiable values, such as a reset value). For example, referring to FIG. 4, once a user input enables the reconfiguration mode (e.g., when the toggle button 321 is switched to “ON”) then the processor (e.g., controller 111) enables modification of the fields for column 339 and column 342, which correspond respectively to the contribution rate and the override amount. As shown in FIG. 4, the values for the contribution rate are modified (via user input) from the first values 352 and 354 to second values 452 and 454 respectively. Furthermore, the values for the override amount are changed (via user input) from first values 355 and 357 to second values 455 and 457 respectively. To save the second values 455 and 457, a save button 460 is selected (e.g., via cursor 462). The second values 455 and 457 are stored (e.g., the second values 455 and 457 overwrite or replace the first values 355 and 357 respectively on the NVRAM 113 of the gaming machine 110). In some embodiments, the processor (e.g., controller 111) modifies a portion of setting(s) (e.g., modifies some first value(s) to the second value(s), such as modifying the contribution rate and/or override value) while preventing modification of additional values to an additional portion of the setting(s) (e.g., prevents modification of the reset value, the maximum value, etc.). In response to the save button 460 being pressed, all checks that are performed on the modified fields at the time of reconfiguration-mode modifications as were performed during initial configuration. For example, for contribution rate, RTP checks are done against the allowed range for the jurisdiction. The rate is also checked to make sure it is within a min-max range provided by the associated wagering game. Furthermore, an override amount is checked to make sure that it is greater than the reset amount provided by game. In some embodiments, the processor (e.g., controller 111) only permits the modifiable values to be set to values higher than previously set (i.e., configuration menu 301 enforces a restriction where only additions or increases to the value(s) of setting(s) 330 are permitted during reconfiguration, and subtractions or reductions to the value(s) are not permitted (i.e., contribution rate and override amount can only be increased, not decreased from previously set values)). If the checks (e.g., on restrictions and/or limits) are not satisfied for the modification, the configuration menu 301 can present a message requiring that the modification satisfy the checks before the modified second value(s) are saved. If the checks are satisfied, the first value(s) are overwritten by the second value(s) within the setting(s) 330. Furthermore, in response to the save button 460 being pressed (and verified against all checks) the first data (saved previously via processing block 202) can be organized or classified into the aforementioned first snapshot of data (see entry 732 in FIG. 7). Furthermore, any second data that is stored for subsequent gaming activity by linked gaming machines (e.g., see processing block 218), can be stored for organization into the second aforementioned snapshot (see entry 731 of FIG. 7).

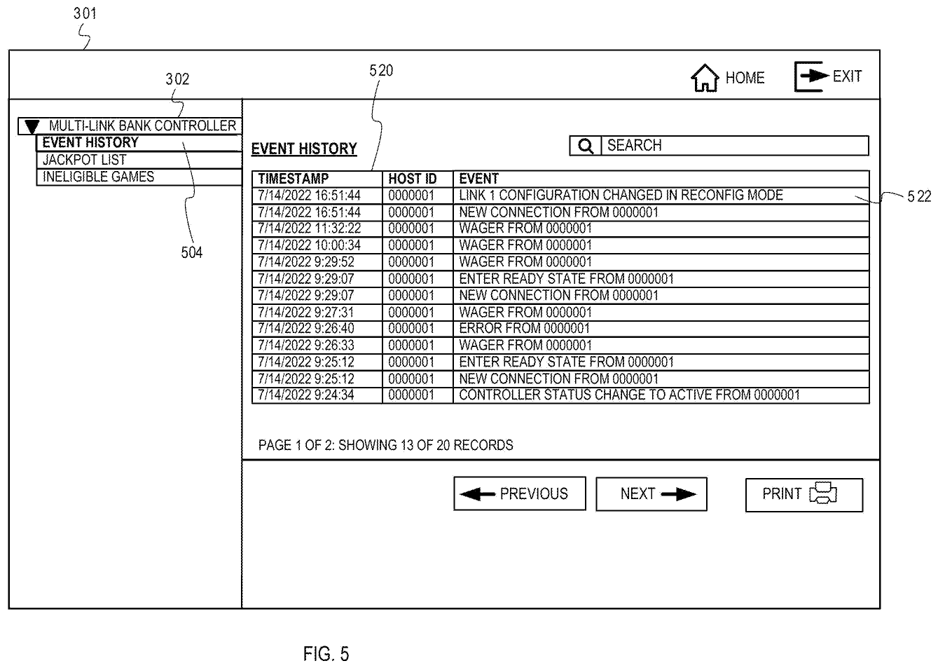

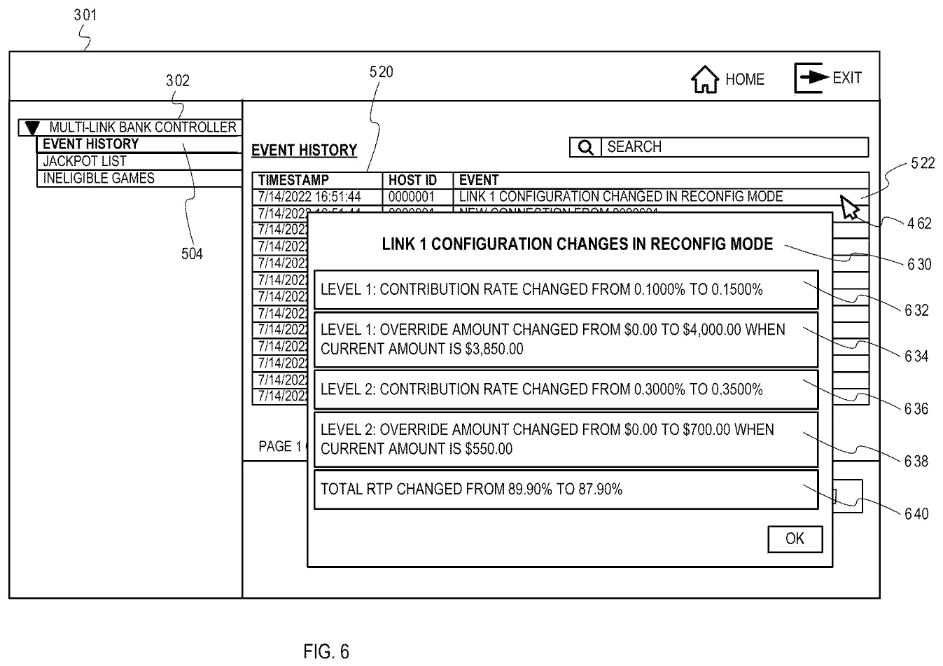

Referring again to FIG. 2, the flow 200 continues at processing block 216, where a processor stores one or more event records of the modification. In some embodiments, the processor stores an event record (in an event history) for each link configuration change. The event history can be stored on the host gaming machine (e.g., on gaming machine 110) as the events relate to generating and maintaining links by the host gaming machine on behalf of the client gaming machines. Details of the configuration changes can be displayed when an event record is pressed or otherwise selected (e.g., via user input). FIG. 5 illustrates an example event history 520 presented by the configuration menu 301 when an option 504 is selected from navigation menu 302. As illustrated in FIG. 5, an entry 522 of the event history 520 indicates an event record for the reconfiguration described in FIG. 4. Furthermore, as illustrated in FIG. 6, the configuration menu 301 can (in response to user input, such as selection of the entry 522 by cursor 462) provide additional details about the modifications. For example, a window 630 appears which includes a section 632 that specifies modification of the contribution rate for the first level (“level 1”) from a first value (i.e., from “0.1000%) to a second value (i.e., to “0.1500%”). The window 630 also includes a section 634 that specifies modification of the override amount for the first level (“level 1”) from a first value (i.e., from “$0.00”) to a second value (i.e., to “$4,000.00”) when the current amount of the progressive jackpot level was at “$3,850.00.” The window 630 further includes a section 636 that specifies modification of the contribution rate for the second level (“level 2”) from a first value (i.e., from “0.3000%) to a second value (i.e., to “0.3500%”). The window 630 also includes a section 638 that specifies modification of the override amount for the second level (“level 2”) from a first value (i.e., from “$0.00”) to a second value (i.e., to “$700.00”) when the current amount of the progressive jackpot level was at “$550.00.” The window 630 also includes a section 640 that specifies a change of an overall RTP from a first value (e.g., from “89.90%”) to a second value (e.g., to “87.90%”), based on the modifications and/or based on one or more additional information (e.g., based on information from the first data 116 and/or the second data 117).

Referring back to FIG. 2, the flow 200 continues at processing block 218, where a processor stores second data made by linked gaming machine(s) while the progressive jackpot setting(s) (including the at least the portion of the setting(s)) are set to the second value(s). The processor stores the second data after the modification of the first value(s) to the second value(s) and while the progressive jackpot is in progress. For example, the processor can (e.g., as controller 111 of the host gaming machine 110) store and classify the second data (e.g., second data 117) for any wagers made by any of the linked gaming machines 110, 120, 130 and/or 140 while at least the portion of the setting(s) 330 are set to the second value(s). The second data may include, but not be limited to, wager amounts, contribution amounts, games played, games won, etc. The processor can generate (organize and save in a persistent memory partition) a snapshot of progressive meters (e.g., in response to a contribution rate change) for one or more games that were played with the previously set value(s). For example, when the save button 460 is selected, the processor stores the snapshot for the first data 116 for any game data generated while the setting(s) 330 were the first value(s). As shown in FIG. 7, the first snapshot can be selected by the entry 732 of dropdown menu 730. Furthermore, the processor can (concurrently or subsequently) generate a second snapshot related to entry 732 of dropdown menu 730 (e.g., in response to selection of the save button 460 when the value(s) are modified again). Furthermore, the processor stores, in the second snapshot, data about games played, total wagered amounts, game wager data, etc. (game data 740) made while the setting(s) 330 were set to the second value(s). The second snapshot can be viewed when the entry 731 is selected from the dropdown menu 730. Jackpot data in table 750 shows data regarding the one or more of the second value(s) (e.g., because entry 731 is selected, the column 751 specifies the second value(s) 452 and 454 of column 339 shown in FIG. 4).

As games are played using the second values 452, 454, 455, and/or 457, the processor records, over time, data for each game played by the linked gaming machines 110, 120, 130 and/or 140. In some embodiments, the snapshot can include information about a total number of times the progressive was awarded or hit (e.g., “Master Total Awarded,” “Master Total Hit,” “Master Last Award,” “Period Total Awarded,” “Period Total Hit,” and “Period Last Award”).

Referring again to FIG. 2, the flow 200 continues at processing block 220, where a processor determines whether a request for a payback analysis is made, such as via user input or via an automatic process. For example, referring to FIG. 3, the processor may present a computed value of the RTP for the field 333 (e.g., each link selected by the dropdown 331 shows a different RTP value within the field 333 based on game play (e.g., contributions) from linked machines using the values in the table 334). In other embodiments, as shown in FIG. 8, a user input can select, from navigation menu 302, option 804 which presents table 820. The table 820 includes a field 822 to present a computed value of payback analysis. FIG. 8 will be described in more detail in reference to processing block 222.

In FIG. 2, the flow 200 continues at processing block 222, where a processor computes a weighted average theoretical payback (WATP) based on a plurality of return-to-player computations (RTPs) for linked gaming machine(s) using the first data and the second data. For example, referring to FIG. 8, the processor computes an RTP 826 using the first data based on the first value(s). The processor further computes a RTP 824 using the second data based on the second value(s). Since changes in contribution rate affect the RTP, in some embodiments, a certain number of records (e.g., the last 10 records for each contribution rate) are stored and used for computing the RTPs 824 and/or 826. The number of records (e.g., the last 10 records) are kept for each client connected to the controller 111. The number of records are also kept for the host gaming machine 110 given that the host gaming machine 110 also runs a client for gaming purposes. As shown in FIG. 3, the processor computes (for field 333) the value 351 (e.g., “89.90%”), which is the RTP 826 shown in FIG. 8. Furthermore, as shown in FIG. 4, the processor computes (for field 333) the value 451 (e.g., “87.90%”), which is the RTP 824 shown in FIG. 8.

The processor can further compute an average value from the RTPs 824 and 826. For example, the processor computes a combined meter value as a weighted average theoretical payback (e.g., WATP 822) based on the plurality of RTPs (e.g., based on RTP 824 and RTP 826).

Referring back to FIG. 2, the flow 200 continues at processing block 224, where a processor presents, via an electronic display, an indication of the requested payback analysis. For example, as shown in FIG. 8, the processor presents the WATP 822 via the configuration menu 301. The configuration menu 301 is presented via a display of a host gaming machine (i.e., via a display of gaming machine 110).

In addition to embodiments described, in some embodiments a processor (e.g., the controller 111) stores, in a memory of a gaming machine in response to a first user input, one or more first values of a setting for a progressive jackpot. In some embodiments, the processor further stores, while the setting is set to the one or more first values, first data made by one or more gaming machines linked to the progressive jackpot. In some embodiments, the processor further detects, after storing the first data and prior to the progressive jackpot being won, a second user input to modify the one or more first values. In some embodiments, the processor further modifies, in response to detecting the second user input, the one or more first values to be one or more second values. In some embodiments, the processor further stores, while the setting is set to the one or more second values, second data made by the one or more gaming machines. The second data is stored after the first data and prior to the progressive jackpot being won. The processor further computes, via electronic analysis by the processor, a theoretical payback for the progressive jackpot based on the first data and the second data. In some embodiments, the processor further presents, via a display of the gaming machine, an indication of the theoretical payback.

Referring now to FIG. 9, there is shown a gaming machine 910 similar to those operated in gaming establishments, such as casinos. With regard to the present invention, the gaming machine 910 may be any type of gaming terminal or machine and may have varying structures and methods of operation. For example, in some aspects, the gaming machine 910 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 910 may take any suitable form, such as floor-standing models as shown, handheld mobile units, bartop models, workstation-type console models, etc. Further, the gaming machine 910 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 910 illustrated in FIG. 9 comprises a gaming cabinet 912 that securely houses various input devices, output devices, input/output devices, internal electronic/electromechanical components, and wiring. The cabinet 912 includes exterior walls, interior walls and shelves for mounting the internal components and managing the wiring, and one or more front doors that are locked and require a physical or electronic key to gain access to the interior compartment of the cabinet 912 behind the locked door. The cabinet 912 forms an alcove 914 configured to store one or more beverages or personal items of a player. A notification mechanism 916, such as a candle or tower light, is mounted to the top of the cabinet 912. It flashes to alert an attendant that change is needed, a hand pay is requested, or there is a potential problem with the gaming machine 910.

The input devices, output devices, and input/output devices are disposed on, and securely coupled to, the cabinet 912. By way of example, the output devices include a primary presentation device 918, a secondary presentation device 920, and one or more audio speakers 922. The primary presentation device 918 or the secondary presentation device 920 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 918, 920, the audio speakers 922, lighting assemblies, and/or other devices associated with presentation are collectively referred to as a “presentation assembly” of the gaming machine 910. The presentation assembly may include one presentation device (e.g., the primary presentation device 918), some of the presentation devices of the gaming machine 910, or all of the presentation devices of the gaming machine 910. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 918 and/or the secondary presentation device 920, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 910. The gaming machine 910 may include a touch screen(s) 924 mounted over the primary or secondary presentation devices, buttons 926 on a button panel, a bill/ticket acceptor 928, a card reader/writer 930, a ticket dispenser 932, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen(s) 924, buttons 926, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 910 includes one or more value input/payment devices and value output/payout devices. In order to deposit cash or credits onto the gaming machine 910, the value input devices are configured to detect a physical item associated with a monetary value that establishes a credit balance on a credit meter such as a “credits” meter. The physical item may, for example, be currency bills, coins, tickets, vouchers, coupons, cards, and/or computer-readable storage mediums. The deposited cash or credits are used to fund wagers placed on the wagering game played via the gaming machine 910. Examples of value input devices include, but are not limited to, a coin acceptor, the bill/ticket acceptor 928, the card reader/writer 930, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 910. The credits may be exchanged for cash at, for example, a cashier or redemption station. Examples of value output devices include, but are not limited to, a coin hopper for dispensing coins or tokens, a bill dispenser, the card reader/writer 930, the ticket dispenser 932 for printing tickets redeemable for cash or credits, a wireless communication interface for transmitting cash or credit data to a nearby mobile device, and a network interface for depositing cash or credits to a remote account via an electronic funds transfer.

Turning now to FIG. 10, there is shown a block diagram of the gaming-machine architecture. The gaming machine 1010 includes game-logic circuitry 1040 (e.g., securely housed within a locked box inside gaming cabinet 912 in FIG. 9). The game-logic circuitry 40 includes a central processing unit (CPU) 1042 connected to a main memory 1044 that comprises one or more memory devices. The CPU 1042 includes any suitable processor(s), such as those made by Intel and AMD. By way of example, the CPU 1042 includes a plurality of microprocessors including a master processor, a slave processor, and a secondary or parallel processor. Game-logic circuitry 1040, as used herein, comprises any combination of hardware, software, or firmware disposed in or outside of the gaming machine 1010 that is configured to communicate with or control the transfer of data between the gaming machine 1010 and a bus, another computer, processor, device, service, or network. The game-logic circuitry 1040, and more specifically the CPU 1042, comprises one or more controllers or processors and such one or more controllers or processors need not be disposed proximal to one another and may be located in different devices or in different locations. The game-logic circuitry 1040, and more specifically a main memory 1044, comprises one or more memory devices which need not be disposed proximal to one another and may be located in different devices or in different locations. The game-logic circuitry 1040 is operable to execute all of the various gaming methods and other processes disclosed herein. The main memory 1044 includes a wagering game unit 1046. In one embodiment, the wagering game unit 1046 causes wagering games to be presented, such as video poker, video black jack, video slots, video lottery, etc., in whole or part.

The game-logic circuitry 1040 is also connected to an input/output (I/O) bus 1048, which can include any suitable bus technologies, such as an AGTL+ frontside bus and a PCI backside bus. The I/O bus 1048 is connected to various input devices 1050, output devices 1052, and input/output devices 1054, such as those discussed above in connection with FIG. 9. The I/O bus 1048 is also connected to a storage unit 1056 and external-system interface 1058, which is connected to external system(s) 1060 (e.g., wagering game networks, casino network 160, etc.).

The external system(s) 1060 includes, in various aspects, a gaming network (e.g., casino network 160), other gaming machines or terminals, a gaming server, a remote controller, communications hardware, or a variety of other interfaced systems or components, in any combination. In yet other aspects, the external system(s) 1060 comprises a player's portable electronic device (e.g., cellular phone, electronic wallet, etc.) and the external-system interface 1058 is configured to facilitate wireless communication and data transfer between the portable electronic device and the gaming machine 1010, such as by a near-field communication path operating via magnetic-field induction or a frequency-hopping spread spectrum RF signals (e.g., Bluetooth, etc.).

The gaming machine 1010 optionally communicates with the external system(s) 1060 such that the gaming machine 1010 operates as a thin, thick, or intermediate client. The game-logic circuitry 1040—whether located within (“thick client”), external to (“thin client”), or distributed both within and external to (“intermediate client”) the gaming machine 1010—is utilized to provide a wagering game on the gaming machine 1010. In general, the main memory 1044 stores programming for a random number generator (RNG), game-outcome logic, and game assets (e.g., art, sound, etc.)—all of which obtained regulatory approval from a gaming control board or commission and are verified by a trusted authentication program in the main memory 1044 prior to game execution. The authentication program generates a live authentication code (e.g., digital signature or hash) from the memory contents and compares it to a trusted code stored in the main memory 1044. If the codes match, authentication is deemed a success and the game is permitted to execute. If, however, the codes do not match, authentication is deemed a failure that must be corrected prior to game execution. Without this predictable and repeatable authentication, the gaming machine 1010, external system(s) 1060, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 1042 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 1042 when executing the game-outcome logic to determine a resultant outcome for that instance of the wagering game. The resultant outcome is then presented to a player of the gaming machine 1010 by accessing the associated game assets, required for the resultant outcome, from the main memory 1044. The CPU 1042 causes the game assets to be presented to the player as outputs from the gaming machine 1010 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 1010 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 1010 may include additional peripheral devices or more than one of each component shown in FIG. 10. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering game outcome, for that particular wagering game instance, is then revealed to the player in due course following initiation of the wagering game. The method comprises the acts of conducting the wagering game using a gaming apparatus, such as the gaming machine 910 depicted in FIG. 9, following receipt of an input from the player to initiate a wagering game instance. The gaming machine 1010 then communicates the wagering game outcome to the player via one or more output devices (e.g., primary presentation device 918 or secondary presentation device 920) through the presentation of information such as, but not limited to, text, graphics, static images, moving images, etc., or any combination thereof. In accord with the method of conducting the wagering game, the game-logic circuitry 1040 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 1040 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 1042 causes the recording of a digital representation of the wager in one or more storage media (e.g., storage unit 1056), the CPU 1042, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 1042 (e.g., the wager in the present example). As another example, the CPU 1042 further, in accord with the execution of the stored instructions relating to the wagering game, causes the primary presentation device 918, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 1040 to determine the outcome of the wagering-game instance. In at least some aspects, the game-logic circuitry 1040 is configured to determine an outcome of the wagering-game instance at least partially in response to the random parameter.

In one embodiment, the gaming machine 1010 and, additionally or alternatively, the external system(s) 1060 (e.g., a gaming server), means gaming equipment that meets the hardware and software requirements for fairness, security, and predictability as established by at least one state's gaming control board or commission. Prior to commercial deployment, the gaming machine 1010, the external system(s) 1060, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 910 may be implemented with hardware and software architectures, circuitry, and other special features that differentiate it from general-purpose computers (e.g., desktop PCs, laptops, and tablets).

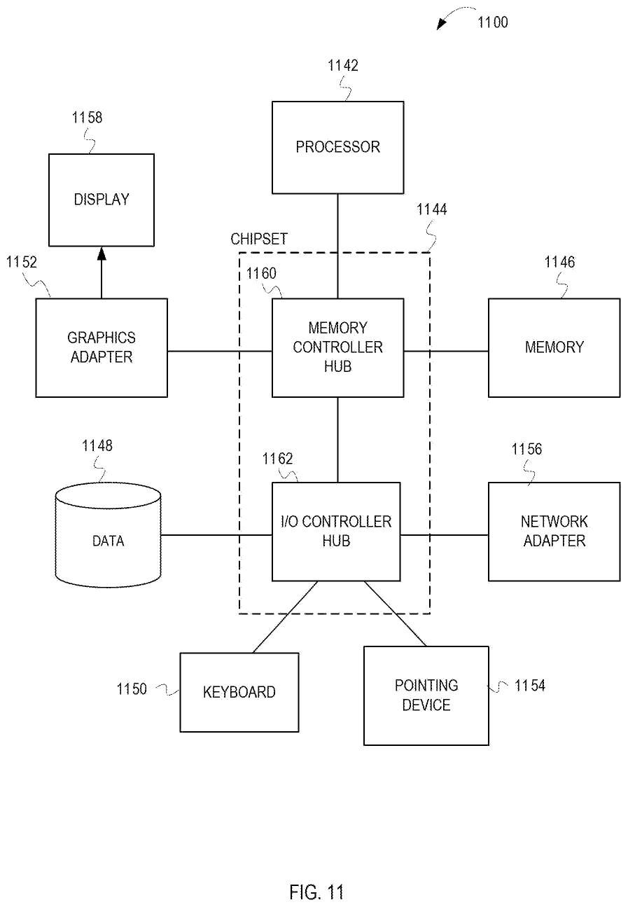

FIG. 11 is shown a block diagram of a computer system 1100 according to one or more embodiments. The computer system 1100 includes at least one processor 1142 coupled to a chipset 1144, as indicated in dashed lines. Also coupled to the chipset 1144 are memory 1146, a storage device 1148, a keyboard 1150, a graphics adapter 1152, a pointing device 1154, and a network adapter 1156. A display 1158 is coupled to the graphics adapter 1152. In one embodiment, the functionality of the chipset 1144 is provided by a memory controller hub 1160 and an I/O controller hub 1162. In another embodiment, the memory 1146 is coupled directly to the processor 1142 instead of to the chipset 1144.

The storage device 1148 is any non-transitory computer-readable storage medium, such as a hard drive, a compact disc read-only memory (CD-ROM), a DVD, or a solid-state memory device (e.g., a flash drive). The memory 1146 holds instructions and data used by the processor 1142. The pointing device 1154 may be a mouse, a track pad, a track ball, or another type of pointing device, and it is used in combination with the keyboard 1150 to input data into the computer system 1100. The graphics adapter 1152 displays images and other information on the display 1158. The network adapter 1156 couples the computer system 1100 to a local or wide area network.

As is known in the art, the computer system 1100 can have different and/or other components than those shown in FIG. 11. In addition, the computer system 1100 can lack certain illustrated components. In one embodiment, the computer system 1100 acting as a gaming server (or remote progressive controller host) may lack the keyboard 1150, pointing device 1154, graphics adapter 1152, and/or display 1158. Moreover, the storage device 1148 can be local and/or remote from the computer system 1100 (such as embodied within a storage area network (SAN)). Moreover, other input devices, such as, for example, touch screens may be included.

The network adapter 1156 (may also be referred to herein as a communication device) may include one or more devices for communicating using one or more of the communication media and protocols discussed above with respect to FIG. 1, FIG. 2, FIG. 3, FIG. 4, FIG. 5, FIG. 6, FIG. 7, or FIG. 8.

In addition, some or all of the components of this general computer system 1100 of FIG. 11 may be used as part of the processor and memory discussed above with respect to the systems or devices described for FIG. 1, FIG. 2, FIG. 3, FIG. 4, FIG. 5, FIG. 6, FIG. 7 or FIG. 8.

In some embodiments, a gaming system may comprise several such computer systems 1100. The gaming system may include load balancers, firewalls, and various other components for assisting the gaming system to provide services to a variety of user devices.

The computer system 1100 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1148, loaded into the memory 1146, and executed by the processor 1142.

FIG. 2 described by way of example above, represents a data processing method (e.g., algorithm) that corresponds to at least some instructions stored and executed by a processor and/or logic circuitry associated with the gaming machine 110, gaming machine 910, gaming machine 1010, computer system 1100, etc. However other embodiments can utilize processors and/or logic circuitry of any of the devices described for FIG. 1, FIG. 2, FIG. 3, FIG. 4, FIG. 5, FIG. 6, FIG. 7, FIG. 8, FIG. 9, FIG. 10 or FIG. 11 to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
detecting, by an electronic processor of a gaming machine in response to user input, a request to reconfigure a portion of a setting of a progressive jackpot while the progressive jackpot is in progress;
storing, by the electronic processor in a memory of the gaming machine, gaming data associated with use of the setting; and
enabling, by the electronic processor in response to storing the gaming data and while the progressive jackpot remains in progress, reconfiguration of the portion of the setting without requiring reconfiguration of an additional portion of the setting.

2. The method of claim 1 further comprising enabling the reconfiguration of the portion of the setting without performing at least one of:
stopping progress of the progressive jackpot;
rebooting the gaming machine; or
deleting the memory of the gaming machine.

3. The method of claim 1 further comprising:
storing, by the electronic processor in the memory of the gaming machine prior to detecting the request, one or more first values for the portion of the setting; and
modifying, by the electronic processor in response to detecting the request, the one or more first values to be one or more second values while preventing modification of additional values for the setting.

4. The method of claim 3, wherein the storing the gaming data comprises:
storing, by the electronic processor while the portion of the setting is set to the one or more first values, a first snapshot of the gaming data made by one or more gaming machines linked to the progressive jackpot, wherein the one or more gaming machines comprise the gaming machine; and
storing, by the electronic processor while the portion of the setting is set to the one or more second values, a second snapshot of the gaming data made by the one or more gaming machines, wherein the second snapshot of the gaming data is stored after the first snapshot of the gaming data and while the progressive jackpot is in progress.

5. The method of claim 4 further comprising:
computing, via electronic analysis by the electronic processor, a theoretical payback for the progressive jackpot based on the first snapshot and the second snapshot; and
presenting, by the electronic processor via a display of the gaming machine, an indication of the theoretical payback.

6. The method of claim 4, wherein the first snapshot comprises one or more first accounting records that specify one or more first contributions, of one or more first wagers, made to the progressive jackpot based on the one or more first values, and wherein the second snapshot comprises one or more second accounting records that specify one or more second contributions, of one or more second wagers, made to the progressive jackpot based on the one or more second values.

7. The method of claim 4, wherein the one or more gaming machines comprise a plurality of gaming machines that utilize the setting concurrently for the progressive jackpot.

8. The method of claim 7, further comprising:
generating, by the electronic processor, the first snapshot in response to detecting one or more first wagers made collectively by the plurality of gaming machines while the progressive jackpot is in progress; and
generating, by the electronic processor, the second snapshot in response to detecting one or more second wagers made collectively by the plurality of gaming machines while the progressive jackpot is in progress.

9. The method of claim 1, further comprising determining, by the electronic processor prior to enabling the reconfiguration of the portion of the setting, that one or more criteria are satisfied for authorization of the reconfiguration of the portion of the setting.

10. The method of claim 9, wherein the determining that the one or more criteria are satisfied comprises determining, by the electronic processor, that a jurisdictional setting associated with the gaming machine authorizes a change in rate of progression of the progressive jackpot.

11. The method of claim 9, wherein the gaming machine comprises a logic box having a logic door, and wherein the determining that the one or more criteria are satisfied comprises one or more of determining, by the electronic processor, that the logic door is in an open state or determining, by the electronic processor, that installation media is inserted into a boot port behind the logic door.

12. The method of claim 1, further comprising preventing, by the electronic processor, either a decrease or subtraction to the portion of the setting.

13. The method of claim 1, further comprising restricting, by the electronic processor, the reconfiguration of the portion of the setting to one or more of a contribution rate to the progressive jackpot or an override amount to the progressive jackpot.

14. A system comprising:
a memory of a gaming machine; and
an electronic processor, of the gaming machine, said electronic processor configured to execute instructions, which when executed, cause the system to perform operations to:
detect, in response to user input, a request to reconfigure a portion of a setting of a progressive jackpot while the progressive jackpot is in progress;
determine, prior to enabling reconfiguration of the portion of the setting, that one or more criteria are satisfied for authorization of reconfiguration of the portion of the setting; and
in response to determination that the one or more criteria are satisfied, enable, without stopping the progressive jackpot, the reconfiguration of the portion of the setting while preventing reconfiguration of an additional portion of the setting.

15. The system of claim 14, wherein the electronic processor is further configured to execute instructions, which when executed, cause the system to perform operations to enable the reconfiguration of the portion of the setting without performing one or more of rebooting the gaming machine or deleting the memory of the gaming machine.

16. The system of claim 14, wherein the instructions which cause the system to determine that the one or more criteria are satisfied includes instructions, which when executed, cause the system to:
store, in the memory of the gaming machine, one or more snapshots of gaming data associated with use of the setting; and
enable the reconfiguration of the portion of the setting in response to storage of the one or more snapshots of gaming data.

17. The system of claim 16, wherein the electronic processor is further configured to execute instructions, which when executed, cause the system to perform operations to:
store, in the memory of the gaming machine prior to detection of the request, one or more first values for the portion of the setting;
modify, in response to detection of the request, the one or more first values to be one or more second values; and
prevent modification of one or more additional values for the setting.

18. The system of claim 17, wherein a first snapshot of the one or more snapshots of gaming data comprises one or more first accounting records that specify one or more first contributions, of one or more first wagers, made, by one or more gaming machines linked to the progressive jackpot based on the one or more first values, and wherein a second snapshot of the one or more snapshots of gaming data comprises one or more second accounting records that specify one or more second contributions, of one or more second wagers, made by the one or more gaming machines linked to the progressive jackpot based on the one or more second values.

19. The system of claim 14, wherein the instructions which cause the system to determine that the one or more criteria are satisfied includes instructions, which when executed, cause the gaming system to determine that a jurisdictional setting associated with the gaming machine authorizes a change to the portion of the setting.

20. The system of claim 14, wherein the electronic processor is further configured to execute instructions, which when executed, cause the system to perform operations to restrict the reconfiguration of the portion of the setting to one or more of a contribution rate to the progressive jackpot or an override amount to the progressive jackpot.
